(19) United States
(12) Patent Application Publication
(10) Pub. No.: US 2009/0146582 A1
(43) Pub. Date: Jun. 11, 2009

(54) Colour rendering in compact fluorescent lamps

(75) Inventor: Lorne A. Whitehead, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: The University of British Columbia, Vancouver (CA)

(21) Appl. No.: 11/952,551

(22) Filed: Dec. 7, 2007

(51) Int. Cl. H05B 41/36; H01J 61/92

(52) U.S. Cl. 315/294; 313/1

(57) ABSTRACT

Compact fluorescent lamps (CFLs) are characterized by impaired colour rendering, due to their low illumination capability near the blood-red edge of the visible spectrum. Red light output by a light emitting diode (LED) has a relatively narrow spectral distribution, and LEDs are able to produce red light with reasonable efficiency. Blending the light output of a CFL with a small amount of blood-red light emitted by one or more inexpensive LEDs improves colour rendering, while reducing the overall energy cost of operating the CFL-LED hybrid lamp.

### TECHNICAL FIELD

Red light output by one or more light emitting diodes is blended with the light output by a compact fluorescent lamp to improve colour rendering.

### BACKGROUND

Significant efforts have been made to convince consumers to replace incandescent light bulbs with compact fluorescent lamps (CFLs), which consume considerably less electrical power while producing light comparable to that output by incandescent light bulbs. However, many consumers have been reluctant to adopt CFLs.

One disincentive to adoption of CFLs is capital cost—in many regions the cost of a CFL, allocated over its operating life, is higher than that of an incandescent light bulb, even when the allocation is adjusted for the incandescent light bulb's considerably shorter operating life.

Another disincentive to adoption of CFLs is impaired colour rendering. Most people find that after their eyes have adapted to the warm glow of an incandescent light bulb, the colours of familiar objects appear natural—a consequence of the continuity and uniformity of the natural black-body emission of sources such as flames, filaments and the sun. This is illustrated in FIG. 1, which shows the relative spectral power distribution of an incandescent light bulb as a function of wavelength. In contrast, CFLs have highly non-uniform spectral power distribution, as seen in FIG. 2, which shows the relative spectral power distribution as a function of wavelength for a warm white CFL (solid line plot) and for a cool white CFL (dashed line plot). Even though CFLs have a correlated colour temperature similar to that of incandescent light bulbs, CFLs distort the apparent colour of objects they illuminate.

It is useful to consider three types of “effective cost” associated with producing a certain quantity of light, namely (1) the perceived disincentive of electrical energy cost per quantity of light, (2) the perceived disincentive of lamp replacement cost per quantity of light, and (3) the perceived disincentive of impaired colour rendering. The perceived disincentive of impaired colour rendering is difficult to quantify, but some inferences can be made by observing the choices people make. It is believed that, in their purchase decisions, consumers either consciously or unconsciously attempt to reduce the sum of the foregoing effective costs.

Megalumen-hour (MLH) units (one MLH=10⁶ lumens per hour) assist in conceptualizing “light for a time period.” One MLH is roughly equivalent to the light output of a 100 watt incandescent light bulb operated continuously for one month. Table 1 presents a rough approximation of the effective costs of a 100 watt incandescent light bulb, expressed in dollars per MLH.

TABLE 1

| | Cost of 100 watt incandescent light bulb |
|---|---|
| Effective cost | per quantity of light in $ per MLH |
| Electrical cost | 2.00 |
| Lamp replacement cost | 0.30 |
| Impaired colour rendering | 0 |
| Total | 2.30 |

Table 1 reveals that the electrical power is relatively expensive and that the incandescent light bulb is relatively inexpensive. In contrast, consider the situation for CFLs as of a few years ago, when the cost of a CFL replacement for a 100 watt incandescent light bulb was about $20 in Canadian (CA) funds. Table 2 presents a rough approximation of the effective costs of a CFL having a purchase price of about CA $20, expressed in dollars per MLH.

TABLE 2

| | Cost of CA $20 CFL |
|---|---|
| Effective cost | per quantity of light in $ per MLH |
| Electrical cost | 0.50 |
| Lamp replacement cost | 1.80 |
| Impaired colour rendering | unknown |
| Total | 2.30 + unknown cost of impaired |
| | colour rendering |

Table 2 reveals that the electrical power is relatively inexpensive and the CFL is relatively expensive. Disregarding the unknown cost of impaired colour rendering, comparison of Tables 1 and 2 suggests that the total effective costs of the two types of bulbs are about the same, implying little or no incentive to switch from an incandescent light bulb to a CFL costing about CA $20. It is possible that the perceived cost of impaired colour rendering was also a factor, but this is unknown. At any rate, it is no surprise that CFL's were not widely adopted when they cost about CA $20. However, CFLs now cost about CA $10 or less. Table 3 presents a rough approximation of the effective costs of a CFL having a purchase price of about CA $10, expressed in dollars per MLH.

TABLE 3

| | Cost of CA $10 CFL |
|---|---|
| Effective cost | per quantity of light in $ per MLH |
| Electrical cost | 0.50 |
| Lamp replacement cost | 0.90 |
| Impaired colour rendering | unknown |
| Total | 1.40 + unknown cost of impaired colour |
| | rendering |

Table 3 suggests that if impaired colour rendering did not matter, then most sensible people would use CFLs costing about CA $10 wherever possible—but they are largely not doing so. One possible explanation for this is that impaired colour rendering does matter. That is, it is possible that consumers' perceive the effective cost of CFLs' impaired colour rendering to be large enough to negate the financial advantage of CFLs over incandescent light bulbs which is revealed by comparison of Tables 1 and 3. For most people, this perception may not result from conscious consideration, but may be an unconscious response to a displeasing characteristic in indoor lighting. For example, most people are very sensitive to the appearance of facial skin tones, as indicators of both health and emotion, and these are distorted by CFLs. Similarly, the colours of natural materials such as woods and red vegetables are distorted by CFLs. Comparison of Tables 1 and 3 thus suggests that the effective perceived cost of impaired colour rendering in a CFL costing about CA $10 is about $2.30 per MLH−$1.40 per MLH 0.90 $ per MLH—the amount that would make the total effective cost approximately equal to that for an incandescent light bulb, as summarized in Table 4.

TABLE 4

| | Cost of CA $10 CFL |
|---|---|
| Effective cost | per quantity of light in $ per MLH |
| Electrical cost | 0.50 |
| Lamp replacement cost | 0.90 |
| Impaired colour rendering | 0.90 |
| Total | 2.30 |

The foregoing simplistic analysis is not meant to suggest that consumers are consciously making purchasing decisions as outlined above, but to provide a simple technique to assist in the evaluation of different lighting approaches.

Light emitting diodes (LEDs) have recently been used for general illumination purposes. LEDs have a very long operating life, but realistic economic considerations require them to be depreciated at roughly 10% per year. LEDs remain expensive from this perspective; LEDs cost roughly CA $5.00 per MLH, so they are clearly not economically feasible for general illumination purposes. As explained below, LEDs can nevertheless be used to address the problem of impaired colour rendering by CFLs.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 graphically depicts relative spectral power distribution, as a function of wavelength (in nanometers), for a prior art incandescent light bulb.

FIG. 2 graphically depicts relative spectral power distribution, as a function of wavelength (in nanometers), for a prior art warm white CFL and for a prior art cool white CFL.

FIG. 3 graphically depicts relative spectral power distribution, as a function of wavelength (in nanometers), for a prior art red LED.

FIG. 4 is a CIE 1931 colour coordinate chromaticity diagram for a incandescent light bulb, a “warm white” CFL, and a cyan-filtered CFL-LED hybrid lamp.

FIG. 5 is an electronic circuit schematic diagram showing a CFL's integrated ballast electrically connected in series, through a full wave bridge rectifier, with three LEDs.

FIG. 6 is an electronic circuit schematic diagram showing an electronic controller for causing CFL-LED hybrid lamp to output light at a predefined correlated colour temperature while operating at any one of a plurality of user selectable dimming setting values.

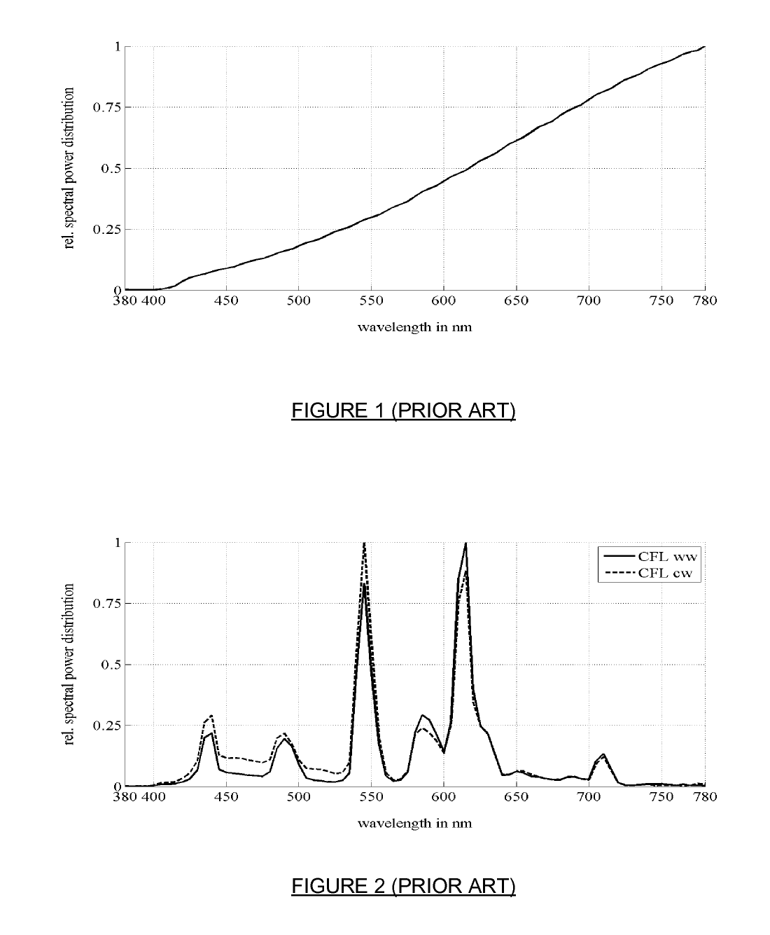

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

CFL-LED Hybrid Lamp

In general, little or no practical advantage is attained by simply combining the light output of two different light sources, in the sense that the light output will in general be the sum of the light output by the two sources, the colour quality will be roughly the average of the colour quality of the two sources, the power consumed will be the sum of the power consumed by the two sources, and the cost will be the sum of the cost of the two sources. The result attained by simply combining two such light sources is thus equivalent to that attainable by providing two lamps, one containing a CFL and the other containing an LED, which in general does not provide a significant practical advantage.

However in certain special circumstances this general result can be superceded. Specifically, the colour rendering capability of light output by a CFL can be improved by blending light output by the CFL with light output by a suitable red LED. In particular, light output by an LED near the blood-red edge of the visible spectrum (i.e. long wavelength red light having a wavelength of about 640 nm) can be blended with bluish-green light output by a CFL to yield white light having improved colour rendering capability. LEDs are a much more efficient source of long wavelength red light than CFLs, whereas CFLs are a relatively inexpensive and efficient source of bluish-green light. In a CFL-LED hybrid lamp, one or more red LEDs efficiently and cost-effectively produce long wavelength red light which is blended with bluish-green light output a CFL to yield white light having improved colour rendering capability. Red light output by a suitable LED can have longer wavelength than light output by the red phosphor typically provided in a CFL. One reason for this is that such phosphors typically have relatively broad spectral distribution as a function of wavelength. Due to this broad distribution, if the peak wavelength was any longer, significant energy would be wasted in producing light at near infra-red wavelengths that are invisible to the human eye. As shown in FIG. 3, a red LED's light output has a relatively narrow spectral distribution as a function of wavelength. As explained below, a CFL's phosphor mix can be adjusted so that white light is obtained when light output by the CFL is blended with light output by the LED.

CFLs' primary deficiency, from the impaired colour rendering perspective, is their low illumination capability near the blood-red edge of the visible spectrum. Colour rendering can be improved by blending a small amount of blood-red light output by one or more LEDs with bluish-green light output by a CFL, without significantly affecting CFLs' energy cost advantages. Although LEDs are expensive if used in quantities suitable for general illumination applications, they are relatively inexpensive if used in the much lower quantities suitable for improving the colour rendering capability of light output by a CFL. About 6 (input) watts of red LED light have been found sufficient to noticeably improve the colour rendering capability of light output by a CFL.

The economic value of a CFL-LED hybrid lamp can be estimated by adding to the costs of the CFL and LED(s) a factor representative of the effective cost of the CFL-LED hybrid lamp's colour impairment reduction capability. This factor can be estimated by comparing spectral measurements of objects such as skin, wood, and various foods when illuminated by a CFL, with corresponding measurements of such objects when illuminated by a CFL-LED hybrid lamp; coupled with an assessment of relative colour impairment by casual human observation of such illuminated objects. Table 5 presents a rough approximation of the effective costs of a CFL-LED hybrid lamp expressed in dollars per MLH, assuming a conservatively estimated colour impairment reduction factor of about three.

TABLE 5

| | CFL | | |
|---|---|---|---|
| | Cost per | LEDs | CFL + LEDs |
| | quantity of | Cost per quantity | Cost per quantity |
| | light in $ | of light in | of light in |
| Effective cost | per MLH | $ per MLH | $ per MLH |
| Electrical cost | 0.50 | 0.20 | 0.70 |
| Lamp replacement | 0.90 | 0.20 | 1.10 |
| cost | | | |
| Impaired colour | 0.90 | N/A | 0.30 (reduced |
| rendering | | | by a factor of |
| | | | 3 compared to |
| | | | CFL) |
| Total | 2.30 | N/A | 2.10 |

Table 5 suggests that the improved colour rendering capability of a CFL-LED hybrid lamp provides a modest incentive to switch away from an incandescent light bulb, since the total effective cost of a CFL-LED hybrid lamp (i.e. 2.10) is less than that of an incandescent light bulb (i.e. 2.30, as shown in Table 1). The capital cost of CFLs is expected to drop by a factor of about two within a few years, and the capital cost of LEDs may also drop, further reducing the total effective cost of a CFL-LED hybrid lamp and thus increasing the incentive to switch away from incandescent light bulbs in favor CFL-LED hybrid lamps.

As shown in Table 5, and as expected, the effective electrical cost of operating a CFL-LED hybrid lamp (i.e. 0.70) exceeds the effective electrical cost of operating a conventional CFL (i.e. 0.50). “Conventional CFL” means a compact fluorescent lamp, as commonly employed for use in interior illumination, in which an electrical discharge in mercury vapour produces ultraviolet radiation that in turn excites phosphors that convert invisible ultraviolet radiation into visible light, with the spectral distribution of this visible light being different for different kinds of phosphors, and for which there is a selection fractional combination of phosphors having different spectral output distributions such that when they combine the resultant chromaticity of the output light lies on or very close to selected place on the black-body curve in the CIE chromaticity diagram. It may seem counter-intuitive to suggest adoption of a lamp which consumes more electric power than a CFL alone, but a more appropriate comparison is with the effective electrical cost of operating an incandescent light bulb (i.e. 2.00, as shown in Table 1). The effective electrical cost of operating a CFL-LED hybrid lamp is about one-third that of operating an incandescent light bulb, yet a CFL-LED hybrid lamp can closely replicate the high colour quality of an incandescent light bulb. This suggests favorable prospects for widespread replacement of incandescent light bulbs with CFL-LED hybrid lamps, and significant consequential reduction of electric power consumption.

Simulating CFL Phosphor Mix Cyan Adjustment Using a Colour Filter

In order to match the luminous colour of an incandescent light bulb, a CFL-LED hybrid lamp should have a slight complementary bluegreen (i.e. cyan) hue. This is best achieved by decreasing the amount of red phosphor in the phosphor mix used to fabricate the CFL. This mix is not currently believed to be commercially available, but it can be simulated by placing an inexpensive colour filter over a conventional CFL, or by blending the light output of a cool-white CFL with light output by other sources, such as LEDs having a greenish tint. Persons skilled in the art will understand that practical commercial embodiments will utilize CFLs having an appropriately adjusted phosphor mix. The cyan-filtered embodiments discussed below demonstrate the effect of modifying the spectral distribution of a CFL.

One may experimentally substitute cyan filters of different densities, vary the percentage of the CFL covered by the respective filters, and vary the intensity of red LED light to achieve the desired colour temperature. This can yield many different light combinations all having roughly the same colour temperature, but having different colour rendering capabilities. For example, a Photoresearch™ PR-650™ Spectrascan™ spectrophotometer was used to collect spectral data for many different cyan-filtered CFL/red LED hybrid lamp embodiments. The LEDs and the cyan-filtered CFL were placed inside a 1 metre integrating sphere, and the spectral radiance at the far wall of the sphere was measured. Measurements were taken over a 10 minute period at 2 minute intervals to ensure that the CFL and LEDs were emitting light at consistent intensity levels. The spectral data was processed to derive a colour rendering index for each cyan filter/LED intensity combination. The colour rendering indices were calculated by the “CIE D-008” computer program made available by the Commission Internationale de l'Eclairage (International Commission on Illumination or “CIE”, headquartered in Vienna, Austria). The program calculated the capability of each cyan-filtered CFL-LED hybrid lamp embodiment to render the 14 CIE test colours, and also calculated the correlated colour temperature and the 1931 CIE chromaticity coordinates of each embodiment.

The first eight CIE test colours are typically averaged to calculate R_{A}, the general colour rendering index. The remaining six colours, for example the ninth colour, R₉, which is saturated red, are not always taken into account when reporting the colour rendering index, but they are used to provide additional information about important visual characteristics of a light source. In order to assess the best cyan-filtered CFL-LED hybrid lamp embodiment, the colour rendering index for each embodiment was analyzed, and the best embodiment was determined to be that having the highest average R_{A}+R₉ values.

The best results were achieved using a Rosco™ Calcolour™ cyan 60 filter to completely cover the sides of the CFL, while leaving the top of the CFL exposed. The cyan-filtered CFL was accompanied by four red LEDs electrically connected in series and operated at 10.5V and 0.467 A.

The CFL was a Sylvania™ soft white 27 W CFL and the LEDs were Lumiled™ 1 W LEDs, but CFLs or LEDs of other brands can be substituted. The “□” symbol in FIG. 4 plots the location of this cyan-filtered CFL-LED hybrid lamp embodiment on the black body curve, with the “Δ” and “⋄” symbols respectively plotting the locations of a warm white CFL and an incandescent light bulb on the same curve.

The calculated correlated colour temperature, chromaticity coordinates, and general colour rendering index results for (a) a cyan-filtered CFL-LED hybrid lamp, (b) a warm white CFL and (c) an incandescent light bulb are provided in Table 6. Table 7 provides the colour rendering index values for the same three light sources. As previously mentioned, R₉ corresponds to saturated red. The Table 7 R₉ colour rendering index value for the CFL lamp alone (−7.4) is extremely low, as expected, since CFLs have low illumination capability near the blood-red edge of the visible spectrum. However, the Table 7 R₉ colour rendering index value for the cyan-filtered CFL-LED hybrid lamp (93) is quite high and is nearly equal to that of the incandescent light bulb (96.4) thus demonstrating the cyan-filtered CFL-LED hybrid lamp's significantly improved colour rendering capability.

TABLE 6

| | | | CIE 1931 | General Colour |
|---|---|---|---|---|
| | | Correlated Colour | Chromaticity | Rendering |
| | | Temperature | Coordinates (x, y) | Index |
| a. | cyan-filtered | 2794° K | 0.4538, 0.4115 | 86.01 |
| | CFL-LED | | | |
| | hybrid | | | |
| b. | warm white | 2817° K | 0.4548, 0.4164 | 83.55 |
| | CFL | | | |
| c. | incandescent | 2393° K | 0.4915, 0.4220 | 98.24 |
| | light bulb | | | |

TABLE 7

| | a. | b. | c. |
|---|---|---|---|
| R₁ | 83.1 | 96.6 | 98.6 |
| R₂ | 94.3 | 95.8 | 98.3 |
| R₃ | 54.4 | 62.0 | 97.9 |
| R₄ | 85.1 | 91.1 | 98.1 |
| R₅ | 92.9 | 86.8 | 98.0 |
| R₆ | 96.3 | 85.3 | 97.5 |
| R₇ | 91.2 | 88.7 | 98.7 |
| R₈ | 90.7 | 62.1 | 98.7 |
| R₉ | 93 | −7.4 | 96.4 |
| R₁₀ | 75.8 | 57.9 | 96.1 |
| R₁₁ | 95.8 | 77.3 | 97.6 |
| R₁₂ | 78.1 | 56.2 | 93.7 |
| R₁₃ | 80.9 | 98.5 | 98.4 |
| R₁₄ | 68.1 | 73.2 | 98.8 |

Modifying CFL Ballast Circuitry to Power LEDs

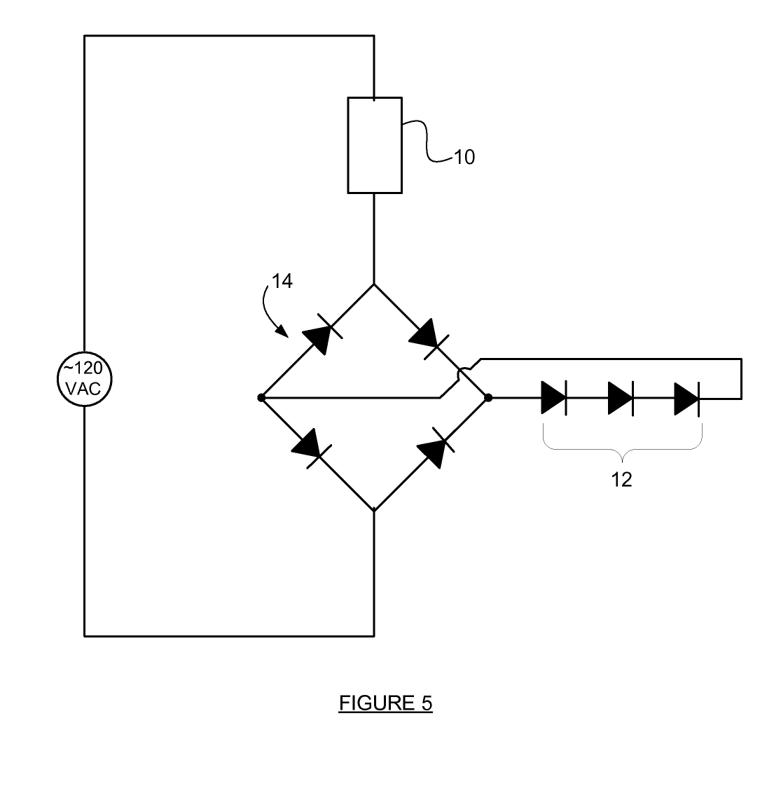

As shown schematically in FIG. 5, CFL 10 has an integrated ballast (i.e. transformer) which limits the electrical current which may pass through the CFL. One or more red LEDs 12 can be electrically connected in series with CFL 10's ballast using a full wave bridge rectifier 14 as shown in FIG. 5.

Designing Fixture Optics to Blend Light Uniformly and Efficiently

Once an appropriate cyan-filtered CFL/LED combination has been determined (it again being noted that this is an illustrative embodiment, and that practical commercial embodiments will utilize CFLs having an appropriately adjusted phosphor mix), a fixture can be used to uniformly and efficiently blend the light output by the two light sources. A suitable fixture can be provided by modifying an inexpensive, commercially-available recessed lighting can, such as a model 429345 Hampton Bay™ flush mount dome fixture. This fixture has a frosted glass cover, an inner diameter of 15 cm and a depth of 10 cm. The fixture's interior can be lined with highly reflective aluminum sheeting to efficiently recycle light rays within the fixture, with white paper lining about the upper third of the fixture to diffuse light rays. The fixture's depth and highly reflective, diffusely reflective internal surfaces enable it to blend light output by the CFL with light output by the LEDs sufficiently that the cyan-filtered CFL-LED hybrid lamp appears to be a single white light source.

Constructing Demonstration Fixtures for Comparison

To facilitate comparison of the cyan-filtered CFL-LED hybrid lamp with commercially available incandescent light bulbs and CFLs, two additional fixtures were prepared as explained in the preceding paragraph. One additional fixture contained a warm white CFL instead of a hybrid lamp. The other additional fixture contained an incandescent light bulb instead of a hybrid lamp. Care was taken to ensure that the three fixtures had substantially similar uniformity, correlated colour temperature and luminance light output characteristics. The fixtures' colour temperatures were adjusted by adding appropriate colour filters. Once all three fixtures appeared to be visually similar, the aforementioned spectrophotometer and integrating sphere was used to measure each fixture's colour temperature and spectral intensity distribution characteristics, which are shown in Table 8.

TABLE 8

| | | | CIE 1931 | General Colour |
|---|---|---|---|---|
| | | Correlated Colour | Chromaticity | Rendering |
| | | Temperature | Coordinates (x, y) | Index |
| a. | cyan-filtered | 2360° K | 0.4972, 0.4262 | 84.2 |
| | CFL-LED | | | |
| | hybrid | | | |
| b. | warm white | 2339° K | 0.4974, 0.4233 | 86.27 |
| | CFL | | | |
| c. | incandescent | 2323° K | 0.4934, 0.4149 | 96.74 |
| | light bulb | | | |

The Table 8 spectral data facilitated verification that the fixtures' calculated colour rendering index values (shown in Table 9) were not changed significantly by addition of the coloured filter to the light sources, as is apparent upon comparison of Tables 7 and 9.

TABLE 9

| | a. | b. | c. |
|---|---|---|---|
| R₁ | 80.2 | 98.5 | 97.5 |
| R₂ | 93.9 | 98.9 | 97.3 |
| R₃ | 49.3 | 64.6 | 96.6 |
| R₄ | 80.7 | 95.7 | 96.7 |
| R₅ | 90.7 | 91.9 | 96.3 |
| R₆ | 98.1 | 94 | 94.2 |
| R₇ | 90.8 | 87.3 | 97.6 |
| R₈ | 89.8 | 59.2 | 97.7 |
| R₉ | 91.8 | −7.7 | 96.8 |
| R₁₀ | 74.6 | 67 | 93.5 |
| R₁₁ | 93.4 | 85.6 | 93.9 |
| R₁₂ | 73 | 64 | 91 |
| R₁₃ | 77.6 | 93 | 96.8 |
| R₁₄ | 64.1 | 73.8 | 98 |

Each fixture's luminance was measured by a luminance meter positioned on the far wall of the aforementioned 1 metre integrating sphere. The luminance of all three fixtures was adjusted to be substantially the same, as shown in Table 10, by adding to the incandescent light bulb and to the standard warm white CFL a gray (i.e. neutral density) filter having appropriate size and density characteristics.

TABLE 10

| | |
|---|---|
| a. Cyan-filtered CFL-LED Hybrid | 89.6 cd/m² |
| b. Warm white CFL | 89.8 cd/m² |
| c. Incandescent | 90.2 cd/m² |

Electronic Dimming Control

An incandescent light bulb can be controllably electronically dimmed to an extremely low level of illumination, facilitating light level adjustment over several orders of magnitude, which is a significant advantage. Such dimming changes the incandescent light bulb's colour temperature, causing the bulb to appear more reddish at lower light levels. A CFL can be controllably and smoothly dimmed to about 10% of its maximum light output level, but the colour temperature of a CFL does not change, regardless of the CFL's light output level—which some consumers may find undesirable. By contrast, the colour temperature of the above-described cyan-filtered CFL-LED hybrid lamp can be controlled by appropriately controlling the LED(s) to yield an illumination result indistinguishable from that of an incandescent light bulb but with considerably lower power consumption. More particularly, a relatively small increase in the LED's light output correspondingly increases the reddish appearance of the CFL-LED hybrid lamp's overall light output, which is consequently very similar to that of an electronically dimmed incandescent light bulb.

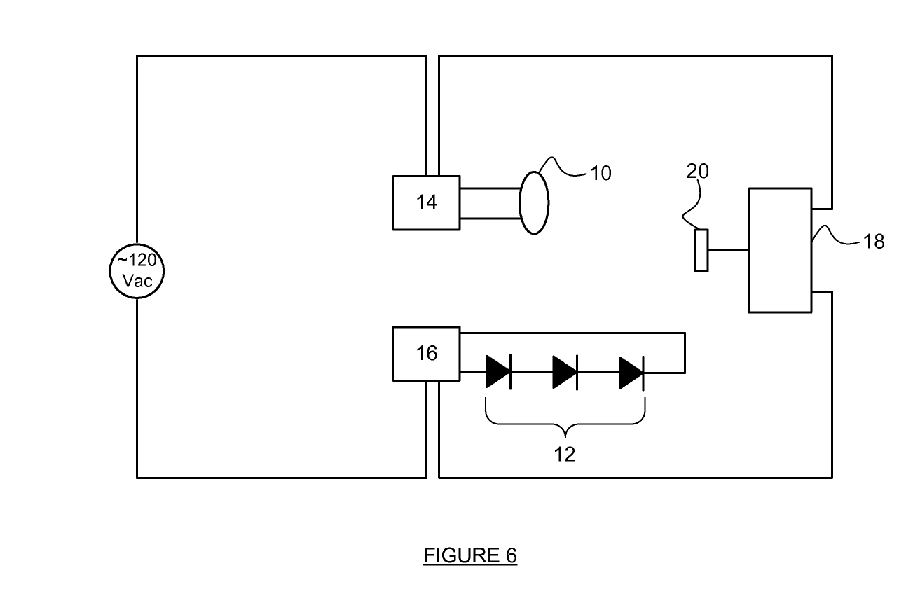

FIG. 6 depicts a CFL-LED hybrid lamp incorporating CFL 10 and one or more LEDs 12. CFL 10 and LEDs 12 are coupled, through their respective power supplies 14, 16 to a 120V alternating current source. Microprocessor-based electronic controller 18 is electronically coupled to CFL 10 and LEDs 12, through power supplies 14, 16 respectively, to cause the CFL-LED hybrid lamp to output light having a predefined correlated colour temperature while operating at any one of a plurality of user selectable dimming setting values. A lookup table stored in memory (not shown) electronically coupled or integral to controller 18 stores the dimming setting values. Each dimming setting value corresponds to the correlated colour temperature of an incandescent light bulb operated at the dimming setting value. For each dimming setting value, the lookup table additionally stores a power ratio value representative of the ratio of LED input power to CFL input power required to cause the CFL-LED hybrid lamp to output light having a correlated colour temperature substantially similar to the correlated colour temperature of an incandescent light bulb operated at that dimming setting value. Upon receipt of a user-supplied dimming setting value for the CFL-LED hybrid lamp, controller 18 retrieves from the lookup table the power ratio value corresponding to the received dimming setting value, then outputs signals to CFL power supply 14 and to LED power supply 16 to cause them to respectively apply power to CFL 10 and LEDs 12 in that ratio, such that the CFL-LED hybrid lamp outputs light having a correlated colour temperature corresponding to the received dimming setting value (i.e. the correlated colour temperature of an incandescent light bulb operated at that dimming setting value).

Alternatively, a suitable analog electric circuit (not shown) can be electronically coupled to controller 18 in substitution for the lookup table. The analog circuit may for example respond to a user-selectable input voltage, by outputting to CFL power supply 14 and to LED power supply 16 signals causing them to respectively apply power to CFL 10 and LEDs 12 in a ratio corresponding to the input voltage, such that the CFL-LED hybrid lamp outputs light having a selected correlated colour temperature.

Correlated Colour Temperature Variation

The correlated colour temperature of a CFL typically varies slightly over time, for example as the CFL ages. Controller 18 can be programmed to compensate for such variation. A correlated colour temperature sensor 20 (FIG. 6) can be electronically coupled to controller 18 and positioned to receive a portion of the light output by CFL 10 and LEDs 12. Correlated colour temperature sensor 20 outputs to controller 18 a signal having a value CCTᵢ representative of the correlated colour temperature of the light output by CFL 10 and LEDs 12. That signal value may be compared by controller 18 with a stored, predefined value CCTₛ representative of the correlated colour temperature of CFL 10 and LEDs 12 when CFL 10 is new and operated at the power level now applied to CFL 10 by CFL power supply 14. If the difference CCTₛ−CCTᵢ exceeds a predefined threshold value then controller 18 may adjust the signal output to LED power supply 16 to increase or decrease the light output of LEDs 12 such that CCTᵢ=CCTₛ.

Phosphor Mix Adjustment

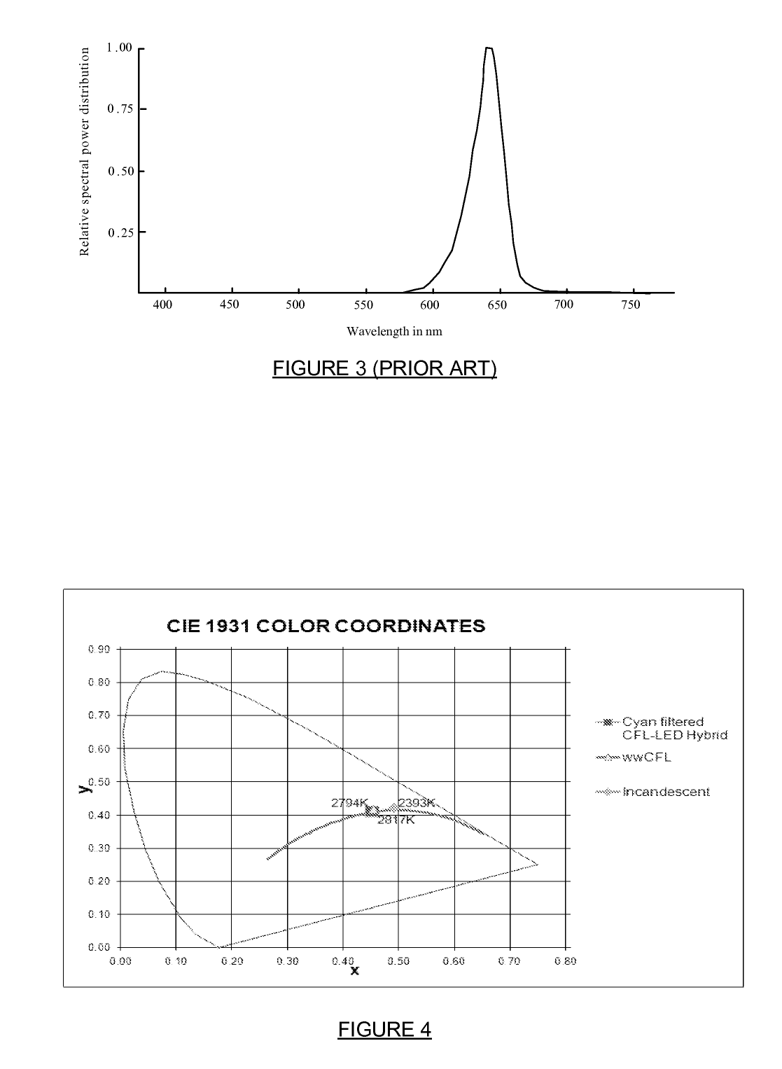

The spectral distribution of light output by commercially available CFLs includes a red wavelength component. However, this is an orange-red having a wavelength of about 625 nm as shown in FIG. 2—not a deep, saturated red characterized by a wavelength of about 640 nm. This is because commercially available CFLs are made in a manner which requires that compromises be made between lamp efficiency and colour rendering capability.

Commercially available CFLs typically contain an inert gas, a small amount of mercury and various phosphors. When the CFL is operated, an electrical discharge excites electrons in the mercury atoms. When these electrons return to their original energy state, ultraviolet photons are emitted. These ultraviolet photons excite electrons in the phosphors, causing them to enter a higher energy state. When the electrons return to their original state they emit photons in the visible wavelength band. The wavelength of the emitted photons depends on the type of phosphor that is used. CFL manufacturers typically select a mixture of phosphors to achieve a desired spectral distribution of the emitted light.

The light output by such commercially available CFLs is “lossy” in the sense that ultraviolet photons contain more energy than visible light photons, with the energy difference being lost as heat. Longer wavelengths correspond to lower photon energies, so CFLs are particularly inefficient red light producers. CFL manufacturers attempt to compensate for this by using red phosphors which emit photons at shorter than ideal (i.e. orange-red) wavelengths, for which the eye has a greater response. (By way of background, it is recalled that the so-called “photopic curve” which represents the spectral response of the human eye to a visual stimulus, attains a maximum value for green wavelengths in the middle of the visible band, and drops off smoothly in either direction. The human eye is less sensitive to the longer wavelengths.)

In contrast, different physical phenomena characterize the operation of LEDs. Specifically, in an LED, a junction is formed between two different semiconducting materials, one having an excess of electrons and the other having an electron deficit. Under certain conditions, when a voltage is applied across the junction, the excess electrons migrate from one side of the junction to the other. The migrating electrons drop into a lower energy state and, in doing so, emit photons, i.e. light. The wavelength of the emitted light can be adjusted, depending on the LED's composition. Red LEDs are particularly efficient, in that substantially all of the input electrical energy is converted into light energy. It is accordingly reasonable from an energy efficiency standpoint to use as LEDs 12 shown in FIGS. 5 and 6, LEDs which emit most of their light at the deep red wavelength range (i.e. about 640 nm). However, such LEDs also unavoidably emit some light in the lower orange-red wavelength range.

Consequently, a CFL-LED hybrid lamp made by combining a commercially available CFL with a red LED will emit too much orange-red light, causing the output light to appear slightly reddish. In order to match the luminous colour of an incandescent light bulb, the CFL should have a slight complementary bluish-green (i.e. cyan) hue. This can be achieved by reducing the amount of red phosphor in the phosphor mix used to fabricate the CFL, such that the CFL contains about one-third less red phosphor than a conventional CFL. Phosphor mix adjustment to achieve the desired effect is a relatively straightforward procedure for CFL manufacturers.

For example, measurement of the spectral distribution of light output by a standard commercial 27 W CFL having a correlated colour temperature of 3000° K, reveals that 50% of the flux leaving the CFL is in the wavelength band between 575-700 nm. This flux percentage is directly proportional to the quantity of red phosphor in the CFL. A one-third reduction in the amount of red phosphor in the CFL's phosphor mix would reduce the CFL's flux output in the wavelength band between 575-700 nm by one-third, namely from 50% to 33%. In other words, the phosphor mix has a proportion of red phosphor which produces a fractional flux output of the CFL in the 575-700 nm wavelength band that is less than two-thirds of the fractional flux output in the 575-700 nm wavelength band of a conventional CFL having the same correlated colour temperature but without the adjusted phosphor mix.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A hybrid lamp, comprising:
a compact fluorescent lamp (CFL) having a first color rendering index;
a red light source having a narrow spectral distribution as a function of wavelength and having a second color rendering index; and
a fixture which blends light output by the CFL with light output by the red light source to produce substantially white light having a third colour rendering index higher than the first colour rendering index and higher than the second colour rendering index.

2. A hybrid lamp as defined in claim 1, wherein the red light source is a light emitting diode (LED).

3. A hybrid lamp as defined in claim 1, further comprising a bluish-green light source, and wherein the fixture further blends bluish-green light output by the bluish-green light source with the light output by the CFL and with the light output by the red light source to produce the substantially white light.

4. A hybrid lamp as defined in claim 1, wherein:
the hybrid lamp has a preselected correlated colour temperature;
the CFL has an adjusted phosphor mix; and
the adjusted phosphor mix has a proportion of red phosphor which produces a fractional flux output of the CFL in the 575-700 nm wavelength band that is less than two-thirds of the fractional flux output in the 575-700 nm wavelength band of a CFL having the preselected correlated colour temperature and not having the adjusted phosphor mix.

5. A hybrid lamp as defined in claim 2, further comprising a bluish-green light source, and wherein the fixture further blends bluish-green light output by the bluish-green light source with the light output by the CFL and with the light output by the red light source to produce the substantially white light.

6. A hybrid lamp as defined in claim 2, wherein:
the hybrid lamp has a preselected correlated colour temperature;
the CFL has an adjusted phosphor mix; and
the adjusted phosphor mix has a proportion of red phosphor which produces a fractional flux output of the CFL in the 575-700 nm wavelength band that is less than two-thirds of the fractional flux output in the 575-700 nm wavelength band of a CFL having the preselected correlated colour temperature and not having the adjusted phosphor mix.

7. A hybrid lamp as defined in claim 3, wherein:
the hybrid lamp has a preselected correlated colour temperature;
the CFL has an adjusted phosphor mix; and
the adjusted phosphor mix has a proportion of red phosphor which produces a fractional flux output of the CFL in the 575-700 nm wavelength band that is less than two-thirds of the fractional flux output in the 575-700 nm wavelength band of a CFL having the preselected correlated colour temperature and not having the adjusted phosphor mix.

8. A hybrid lamp as defined in claim 1, further comprising:
a correlated colour temperature sensor for receiving light output by the hybrid lamp and for producing a correlated colour temperature signal having a value representative of the correlated colour temperature of the light output by the hybrid lamp;
a controller electronically coupled to the correlated colour temperature sensor to receive the correlated colour temperature signal;
the controller further electronically coupled to the red light source; and
the controller operable to vary the light output of the red light source if the value of the correlated colour temperature signal differs from a predefined value by more than a predefined amount.

9. A hybrid lamp as defined in claim 1, further comprising:
a CFL power supply electronically coupled to the CFL;
a red light source power supply electronically coupled to the red light source;
a controller electronically coupled to the CFL power supply and to the red light source power supply;
the controller operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

10. A hybrid lamp as defined in claim 1, further comprising:
a CFL power supply electrically connected to the CFL; and
a red light source power supply electrically connected to the red light source and electrically connected in series with the CFL power supply.

11. A hybrid lamp as defined in claim 2, further comprising:
a CFL power supply electronically coupled to the CFL;
a red light source power supply electronically coupled to the red light source;
a controller electronically coupled to the CFL power supply and to the red light source power supply;
the controller operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

12. A hybrid lamp as defined in claim 4, further comprising:
a CFL power supply electrically connected to the CFL; and
a red light source power supply electrically connected to the red light source and electrically connected in series with the CFL power supply.

13. A hybrid lamp as defined in claim 5, further comprising:
a correlated colour temperature sensor for receiving a portion of the light output by the hybrid lamp and for producing a correlated colour temperature signal having a value representative of the correlated colour temperature of the light output by the hybrid lamp;
a controller electronically coupled to the correlated colour temperature sensor to receive the correlated colour temperature signal;
the controller further electronically coupled to the red light source; and
the controller operable to vary the light output of the red light source if the value of the correlated colour temperature signal differs from a predefined value by more than a predefined amount.

14. A hybrid lamp as defined in claim 5, further comprising:
a CFL power supply electronically coupled to the CFL;
a red light source power supply electronically coupled to the red light source;
a controller electronically coupled to the CFL power supply and to the red light source power supply;
the controller operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

15. A hybrid lamp as defined in claim 2, further comprising a bluish-green light source, and wherein:
the fixture further blends bluish-green light output by the bluish-green light source with the light output by the CFL and with the light output by the red light source to produce the substantially white light;
the hybrid lamp has a preselected correlated colour temperature;
the CFL has an adjusted phosphor mix; and
the adjusted phosphor mix has a proportion of red phosphor which produces a fractional flux output of the CFL in the 575-700 nm wavelength band that is less than two-thirds of the fractional flux output in the 575-700 nm wavelength band of a CFL having the preselected correlated colour temperature and not having the adjusted phosphor mix.

16. A hybrid lamp as defined in claim 2, further comprising:
a CFL power supply electrically connected to the CFL;
a red light source power supply electrically connected to the red light source and electrically connected in series with the CFL power supply;
wherein:
the hybrid lamp has a preselected correlated colour temperature;
the CFL has an adjusted phosphor mix; and
the adjusted phosphor mix has a proportion of red phosphor which produces a fractional flux output of the CFL in the 575-700 nm wavelength band that is less than two-thirds of the fractional flux output in the 575-700 nm wavelength band of a CFL having the preselected correlated colour temperature and not having the adjusted phosphor mix.

17. A hybrid lamp as defined in claim 3, further comprising:
a correlated colour temperature sensor for receiving a portion of the light output by the hybrid lamp and for producing a correlated colour temperature signal having a value representative of the correlated colour temperature of the light output by the hybrid lamp;
a controller electronically coupled to the correlated colour temperature sensor to receive the correlated colour temperature signal;
the controller further electronically coupled to the red light source; and
the controller operable to vary the light output of the red light source if the value of the correlated colour temperature signal differs from a predefined value by more than a predefined amount;
wherein:
the hybrid lamp has a preselected correlated colour temperature;
the CFL has an adjusted phosphor mix; and
the adjusted phosphor mix has a proportion of red phosphor which produces a fractional flux output of the CFL in the 575-700 nm wavelength band that is less than two-thirds of the fractional flux output in the 575-700 nm wavelength band of a CFL having the preselected correlated colour temperature and not having the adjusted phosphor mix.

18. A hybrid lamp as defined in claim 15, further comprising:
a CFL power supply electronically coupled to the CFL;
a red light source power supply electronically coupled to the red light source;
a controller electronically coupled to the CFL power supply and to the red light source power supply;
the controller operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

19. A hybrid lamp as defined in claim 11, further comprising:
a correlated colour temperature sensor for receiving a portion of the light output by the hybrid lamp and for producing a correlated colour temperature signal having a value representative of the correlated colour temperature of the light output by the hybrid lamp;
the controller electronically coupled to the correlated colour temperature sensor to receive the correlated colour temperature signal; and
the controller operable to vary the light output of the red light source if the value of the correlated colour temperature signal differs from a predefined value by more than a predefined amount.

20. A hybrid lamp as defined in claim 15, further comprising:
a CFL power supply electrically connected to the CFL; and
a red light source power supply electrically connected to the red light source and electrically connected in series with the CFL power supply.

21. A hybrid lamp as defined in claim 6, further comprising:
a CFL power supply electronically coupled to the CFL;
a red light source power supply electronically coupled to the red light source;
a controller electronically coupled to the CFL power supply and to the red light source power supply;
the controller operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

22. A hybrid lamp as defined in claim 6, further comprising:
a correlated colour temperature sensor for receiving a portion of the light output by the hybrid lamp and for producing a correlated colour temperature signal having a value representative of the correlated colour temperature of the light output by the hybrid lamp;
a CFL power supply electronically coupled to the CFL;
a red light source power supply electronically coupled to the red light source;
a controller electronically coupled to the correlated colour temperature sensor to receive the correlated colour temperature signal;
the controller further electronically coupled to the CFL power supply and to the red light source power supply;
the controller operable to vary the light output of the red light source if the value of the correlated colour temperature signal differs from a predefined value by more than a predefined amount;
the controller further operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

23. A hybrid lamp as defined in claim 4, further comprising:
a correlated colour temperature sensor for receiving a portion of the light output by the hybrid lamp and for producing a correlated colour temperature signal having a value representative of the correlated colour temperature of the light output by the hybrid lamp;
a CFL power supply electronically coupled to the CFL;
a red light source power supply electronically coupled to the red light source;
a controller electronically coupled to the correlated colour temperature sensor to receive the correlated colour temperature signal;
the controller further electronically coupled to the CFL power supply and to the red light source power supply;
the controller operable to vary the light output of the red light source if the value of the correlated colour temperature signal differs from a predefined value by more than a predefined amount;
the controller further operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

24. A hybrid lamp as defined in claim 15, further comprising:
a correlated colour temperature sensor for receiving a portion of the light output by the hybrid lamp and for producing a correlated colour temperature signal having a value representative of the correlated colour temperature of the light output by the hybrid lamp;
a CFL power supply electronically coupled to the CFL;
a red light source power supply electronically coupled to the red light source;
a controller electronically coupled to the correlated colour temperature sensor to receive the correlated colour temperature signal;
the controller further electronically coupled to the CFL power supply and to the red light source power supply;
the controller operable to vary the light output of the red light source if the value of the correlated colour temperature signal differs from a predefined value by more than a predefined amount;
the controller further operable to output a CFL power signal and a red light source power signal, the CFL power signal having a first value corresponding to a first correlated colour temperature, the red light source power signal having a second value corresponding to a second correlated colour temperature;
the CFL power supply responsive to the CFL power signal to cause the CFL to output light having the first correlated colour temperature;
the red light source power supply responsive to the red light source power signal to cause the red light source to output light having the second correlated colour temperature; and
wherein the ratio of the first value to the second value is selectable by a user of the hybrid lamp.

25. A method of improving the colour rendering capability of light output by a compact fluorescent lamp (CFL), the method comprising:
operating the CFL to output light;
operating a red light source to output red light having a narrow spectral distribution as a function of wavelength; and
blending the light output by the CFL with the light output by the red light source to produce substantially white light.

26. A method as defined in claim 25, wherein the red light source is a light emitting diode (LED).

27. A method as defined in claim 25, wherein the red light has a wavelength of about 640 nanometres.

28. A method as defined in claim 25, further comprising:
operating a bluish-green light source to output bluish-green light; and
blending the light output by the bluish-green light source with the light output by the CFL and with the light output by the red light source to produce the substantially white light.

29. A method as defined in claim 28, wherein the bluish-green light source is an LED.
